(19) United States
(12) Patent Application Publication
(10) Pub. No.: US 2013/0220048 A1
(43) Pub. Date: Aug. 29, 2013

(54) RESIN GEAR AND MANUFACTURING METHOD OF THE SAME

(71) Applicant: CANON KABUSHIKI KAISHA, (US)

(72) Inventor: Gaku Iijima, Yokohama-shi (JP)

(73) Assignee: CANON KABUSHIKI KAISHA, Tokyo (JP)

(21) Appl. No.: 13/777,867

(22) Filed: Feb. 26, 2013

(30) Foreign Application Priority Data
Feb. 29, 2012 (JP) 2012-043965

(51) Int. Cl. F16H 55/06

(52) U.S. Cl. CPC F16H 55/06
USPC 74/434; 264/318; 264/40.1

(57) ABSTRACT

In a resin gear, which has a height h1 of a rim on a side including a gate from a surface including the gate of the web, a thickness T1 of the rim on the side including the gate, a height h2 of the rim on a side opposite to the side including the gate from a surface opposite to the surface including the gate of the web, and a thickness T2 of the rim on the side opposite to the side including the gate and in which h1≧h2, it is configured so that T1h1<T2h2. Thereby, the shrinkage difference of the rim is reduced to a minimum.

### BACKGROUND OF THE INVENTION

1. Field of the Invention

The present disclosure relates to a resin gear formed by injection molding and a manufacturing method of the resin gear.

2. Description of the Related Art

A resin gear is used as a power transmission component in a wide range of mechanical products including OA devices such as a copier and a printer, consumable items such as an ink cartridge, and small precision instruments such as a digital camera and a video camera. Conventionally, the resin gear, which is a power transmission component, is used as a spur gear and a helical gear and the accuracy standards such as an addendum circle size and an engagement error (JGMA 116-02) are set according to usage and purpose of the resin gear. In recent years, mechanical products are desired to have high functionality and high quality, so that high quality resin gears are required.

As a method for evaluating the accuracy of such resin gears, there is a total alignment error (JIS B 1702 and JIS B 1752) measurement. This measurement detects a difference between an actual tooth trace curve and a theoretical curve corresponding to a face width within a necessary inspection range on a pitch cylinder as the amount of error. The total alignment error closely relates to tooth bearing of a gear. When the total alignment error is large, the tooth bearing concentrates on the face width end and may degrade transmission accuracy or cause noise.

The degradation of the total alignment error is largely due to shrinkage behavior during injection molding. As a factor that affects the shrinkage behavior, there is a temperature variation in the entire gear during the injection molding. In particular, in a gear having a web-shaped portion and a rim-shaped portion, the temperature change after the molding is different depending on the position in the molded component. Therefore, the amount of shrinkage of the resin gear varies depending on the position in the molded component. As a result, it may cause degradation of the total alignment error.

To solve this problem, in a conventional technique, it is disclosed that the total alignment error is decreased by suppressing a phenomenon of sink mark and warping by defining thicknesses of predetermined positions of a resin gear.

For example, Japanese Patent Laid-Open No. 2004-138137 discloses a technique for decreasing the total alignment error by averaging the amount of shrinkage of the rim along the face width direction by gradually decreasing the thickness of the rim from both ends in the face width direction of the rim to a connection portion between the rim and the web.

Japanese Patent Laid-Open No. 9-166199 discloses a technique in which, in a gear where a gate is placed on a web, the thickness of the web is the greatest at the gate portion and the thickness of the web is gradually thinned toward a connection portion with a rib, so that heat accumulation is suppressed from affecting the total alignment error.

One of the factors to degrade the total alignment error of a resin gear is the shrinkage behavior during injection molding. In particular, a large factor to degrade the total alignment error is the shrinkage behavior with inclination of the rim.

The shrinkage behavior with inclination of the rim is a factor to degrade the total alignment error of many resin gears. The shrinkage behavior with inclination of the rim is a phenomenon in which the total alignment error is degraded by the inclination of the rim, that is, the shrinkage of the rim having teeth. Normally, a tooth of a gear forms a shape called an involute curve. In the tooth having this curve, generally, the root portion of the tooth is the thickest and the thickness becomes thinner toward the tooth tip. The total alignment error is a result of continuously measuring an intersection position between an outer shape of the tooth having the involute curve and a reference circle (theoretical pitch circle) in the axis direction. Therefore, if the rim is deformed, the measurement point changes in the axis direction. As a result, a problem occurs in which the total alignment error increases.

Usually, an injection mold has resin flow paths such as a primary sprue, a runner, and a secondary sprue in the fixed side mold. In recent years, a hot runner system is often formed in the fixed side mold in order to effectively use resin material. In this way, many molds have a heat source such as resin paths in the fixed side mold. Therefore, the temperature of the fixed side mold tends to be high. The temperature difference between the fixed side mold and the movable side mold is a factor to cause a difference of shrinkage of a molded component between the fixed side mold and the movable side mold. As a result, a problem occurs in which the rim is inclined.

FIGS. 8A and 8B show an example of a resin gear. Reference numeral 111 denotes a rim formed into a cylindrical shape, reference numeral 112 denotes a tooth formed on an outer circumference surface of the rim, and reference numeral 113 denotes a web which is bonded to a central inner circumference surface of the rim in the axis direction and which extends in a disk shape toward a center 115 of the gear. Reference numeral 116 denotes a position of a gate for injecting a resin when forming the resin gear and denotes a case in which the resin is injected from above the web. In FIG. 8A, dashed lines 119 show a state in which the rim 111 having the tooth 112 is deformed and inclined inward. A deformation amount of addendum circle at a rim end portion 122 is indicated by r. Normally, the gate 116 is disposed on the fixed side mold. A resin is injected into a cavity from the gate 116. When molding the gear, the temperature of the fixed side mold having the gate is high, so that the shrinkage of the rim on the side having the gate (on the side of the fixed side mold) increases and the rim is inclined inward. FIG. 8B is a diagram showing a position 120 of a tooth at a rim end portion 123 and a position 121 of a tooth at another rim end portion 122 as seen from the VIIIB direction in FIG. 8A. FIG. 8B shows a state in which the deformation amount of addendum circle is r1. When the rim is deformed and inclined in this way, it is known that the intersection position between the reference circle (theoretical pitch circle) and the outer shape of the tooth changes (the amount of change is u). Whether the resin gear is a helical gear or a spur gear, as the amount of inclination r (r1) of the rim having teeth increases, the amount of change u increases.

The aforementioned Japanese Patent Laid-Open No. 2004-138137 discloses a technique for decreasing the shrinkage difference of the rim by gradually decreasing the thickness of the rim from both ends in the face width direction of the rim to a connection portion between the rim and the web. However, Patent Laid-Open No. 2004-138137 considers only a gear in which the web is connected to an approximately central position of the rim in the face width direction, so that it is impossible to eliminate influence of the temperature difference between the fixed side mold and the movable side mold.

Although the aforementioned Japanese Patent Laid-Open No. 9-166199 discloses a technique for eliminating influence of the heat accumulation by gradually decreasing the thickness of the web toward the connection portion between the web and the rim, there is a problem that the influence due to the temperature difference between the fixed side mold and the movable side mold is not eliminated in the same manner as in the aforementioned Japanese Patent Laid-Open No. 2004-138137.

An aspect of the invention related to the present application provides a resin mold gear and a manufacturing method of the resin mold gear which can suppress the shrinkage difference of the rim due to the temperature difference between the fixed side mold and the movable side mold without using a special device and without a complicated structure of the mold.

### SUMMARY OF THE INVENTION

A resin gear of the present disclosure includes a rim, teeth formed on an outer circumference of the rim, a web bonded to an inner circumference surface of the rim, and, on one surface of the web, a gate for injecting melted resin. In the resin gear, which has a height h1 of the rim on a side including the gate from a surface including the gate of the web, a thickness T1 of the rim on the side including the gate, a height h2 of the rim on a side opposite to the side including the gate from a surface opposite to the surface including the gate of the web, and a thickness T2 of the rim on the side opposite to the side including the gate and in which h1≧h2, T1h1<T2h2 is established.

A molding method of a resin gear of the present invention is a molding method of a resin gear in which a resin gear including a rim is molded by injecting melted resin into a mold including a cavity formed by at least a fixed side mold and a movable side mold. The resin gear is molded so that a thickness of a cavity for forming the rim formed by the fixed side mold is smaller than a thickness of a cavity for forming the rim formed by the movable side mold.

A manufacturing method of a resin gear of the present invention is a molding method of a resin gear in which a resin gear including a rim is molded by injecting melted resin into a mold including a cavity formed by at least a fixed side mold and a movable side mold. The manufacturing method includes a step of taking out a resin gear molded by injecting melted resin into a mold for molding the resin gear in which a thickness of a cavity for forming the rim formed by the fixed side mold and a thickness of a cavity for forming the rim formed by the movable side mold are the same and cooling the melted resin, a step of storing the resin gear which is taken out, a step of measuring an amount of inclination of the rim after the storing, a step of modifying the mold so that the thickness of the cavity for forming the rim formed by the fixed side mold is reduced on the basis of the amount of inclination of the rim, and a step of molding a resin gear by using the modified mold.

Inventive aspects of the present disclosure can at least suppress the phenomenon in which the rim of the gear is inclined due to the temperature difference between the fixed side mold and the movable side mold during the injection molding.

Further features of the present invention will become apparent from the following description of exemplary embodiments with reference to the attached drawings.

### BRIEF DESCRIPTION OF THE DRAWINGS

FIGS. 1A to 1C are schematic diagrams showing a resin gear according to a first embodiment.

FIG. 2 is a flowchart showing an example of a manufacturing method of a resin gear.

FIG. 3 is a schematic cross-sectional view of a mold for manufacturing a resin gear.

FIGS. 4A and 4B are schematic diagrams showing a state of a resin gear after storing the resin gear.

FIGS. 5A and 5B are schematic diagrams showing a resin gear according to a second embodiment.

FIG. 6 is a schematic diagram showing a resin gear according to a third embodiment.

FIG. 7 is a schematic diagram showing a resin gear according to a fourth embodiment.

FIGS. 8A and 8B are schematic diagrams showing an example of a conventional resin gear.

### DESCRIPTION OF THE EMBODIMENTS

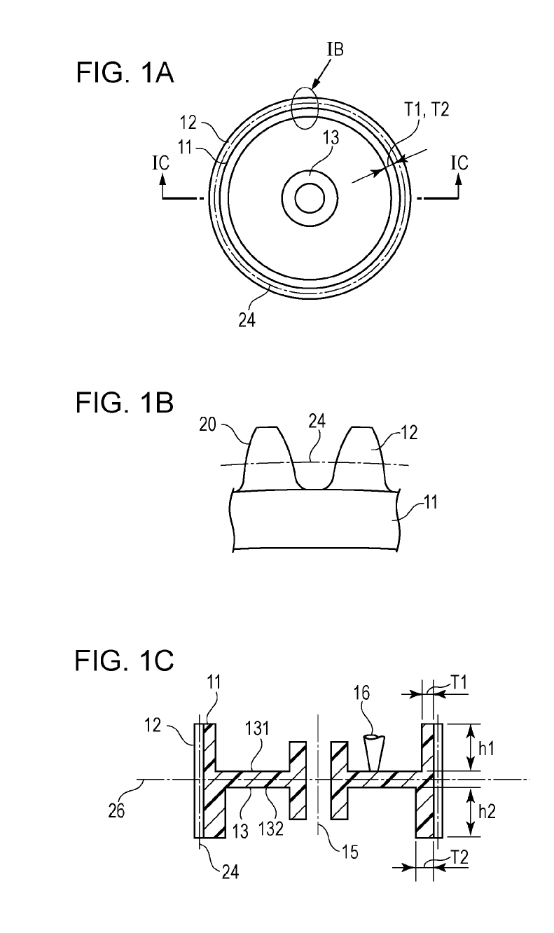

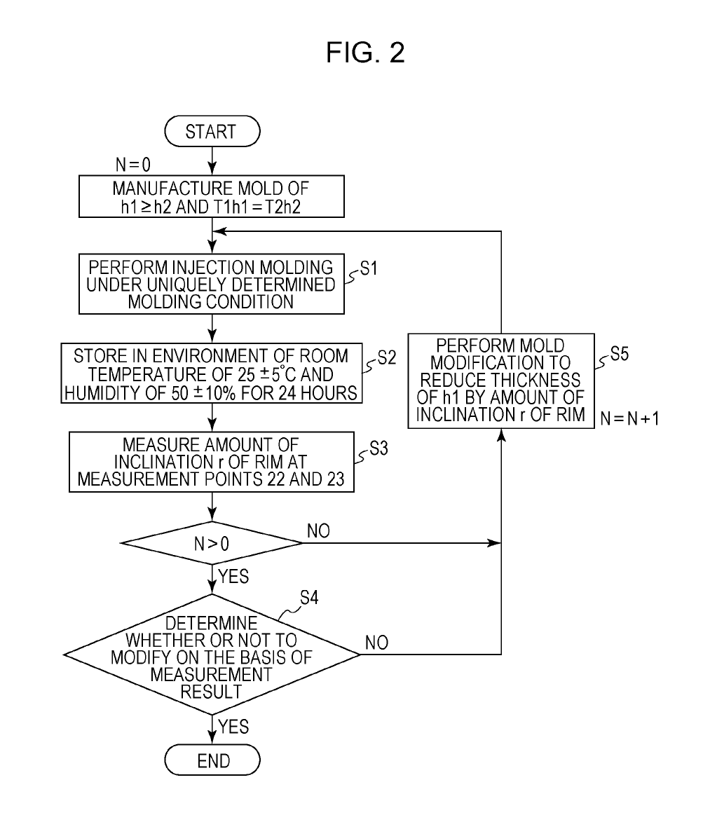

FIGS. 1A to 1C and FIG. 2 are diagrams best illustrating the features of the present disclosure. FIGS. 1A to 1C are schematic diagrams showing a resin gear representing a first embodiment disclosed herein. FIG. 1A is a top view. FIG. 1B is an enlarged view of a IB portion in FIG. 1A. FIG. 1C is a cross-sectional view taken along a line IC-IC in FIG. 1A. In FIGS. 1A to 1C, reference numeral 11 denotes a rim of the resin gear, which is formed into a concentric cylindrical shape with respect to a center 15 of the gear. Reference numeral 11 denotes a teeth portion, which is formed on the outer circumference of the rim. Reference numeral 13 denotes a web which is bonded to the inner circumference of the rim and extends in a disk shape toward the center 15 of the gear. Reference numeral 16 denotes a position of a gate which is an injection inlet of a melted resin and is disposed on one surface of the web. Reference numeral 131 denotes a surface (first surface) including the gate of the web, reference numeral 132 denotes a surface (second surface) opposite to the surface including the gate of the web, and reference numeral 26 denotes a central plane in the thickness direction of the web. The gate is disposed on the surface (first surface) including the gate of the web. Reference symbol h1 denotes a height from the surface (first surface) including the gate of the web and reference symbol T1 denotes a thickness of the rim on the side (side of the first surface) including the gate. Reference symbol h2 denotes a height from the surface (second surface) opposite to the surface including the gate of the web and reference symbol T2 denotes a thickness of the rim on the side (side of the second surface) opposite to the surface including the gate. The side (side of the first surface) including the gate is a side including the surface including the gate of the web when the resin gear is cut along the central plane 26 of the web. The side (side of the second surface) opposite to the surface including the gate is a side opposite to the surface including the gate of the web when the resin gear is cut along the central plane 26 of the web. The resin gear is often manufactured by polyacetal which is a crystalline resin and is manufactured by injection molding using, for example, Tenac (registered trademark) manufactured by Asahi Kasei Chemicals Corporation. Polyamide, polycarbonate, ABS resin, and the like can be used in addition to polyacetal.

In the embodiment shown in FIGS. 1A to 1C, the volume of the rim on the side including the gate can be reduced. As a result, the influence of the heat can be reduced, so that it is possible to suppress the deformation of the rim caused by the heat. Thereby, it is possible to reduce the amount of change of the tooth on the theoretical pitch circle which directly affects the total alignment error, so that it is possible to mold an accurate resin gear.

FIG. 2 is a flowchart showing an example of a manufacturing method of the resin gear of the present disclosure. A molding method of a resin gear will be described in which a resin gear including a rim is molded by injecting melted resin into a mold including a cavity formed by at least a fixed side mold and a movable side mold.

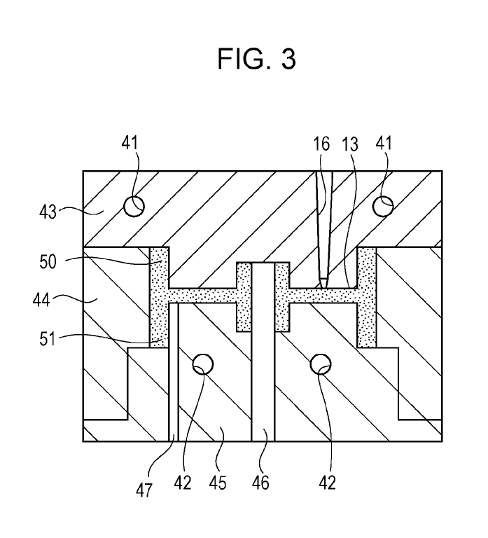

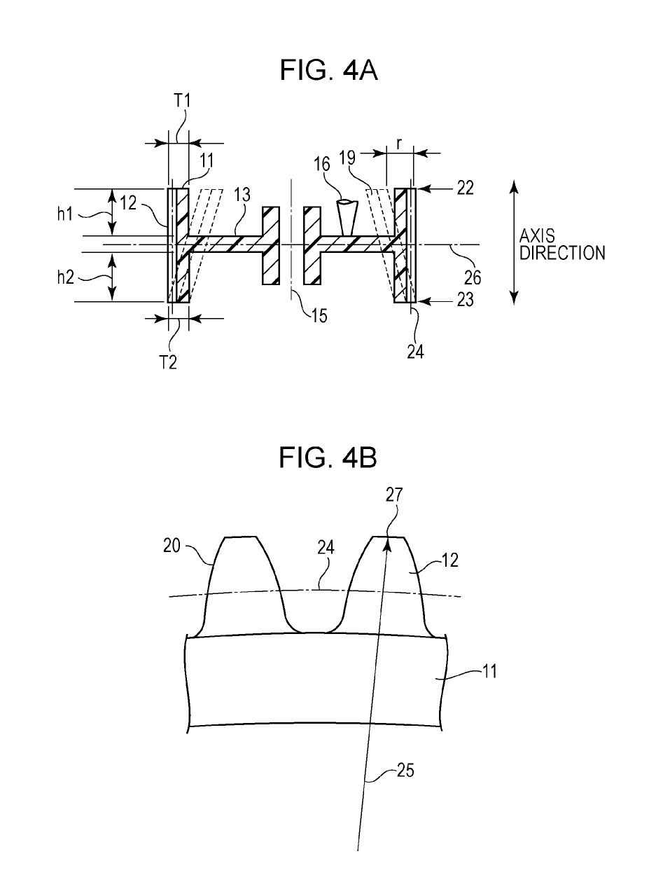

First, in step S1 in the flowchart, injection molding is performed by using a mold in which a thickness T1 and a height h1 of the rim on the side including the gate of the resin gear to be molded and a thickness T2 and a height h2 of the rim on the side opposite to the side including the gate have a relationship of h1≧h2 and T1h1=T2h2. In this case, the molding cycle and the molding condition are arbitrarily determined. However, the molding cycle and the molding condition are uniquely determined according to yield cycle time and production environment. FIG. 3 shows an example of a schematic cross-sectional view of the mold in this case. FIG. 4 shows a resin gear which is a molded component molded by this mold. The same reference numerals are given to the same components as those in FIGS. 1A to 1C and the description thereof is omitted. In FIG. 3, reference numeral 43 denotes the fixed side mold and reference numeral 45 denotes the movable side mold. Reference numeral 44 denotes a teeth portion forming piece in which a teeth portion for transferring a teeth shape is formed. Reference numeral 46 denotes an axis forming piece for forming a cylindrical portion for inserting a rotation shaft into the center of the gear. A cavity is formed in the mold by the fixed side mold 43, the movable side mold 45, the teeth portion forming piece 44, and the axis forming piece 46. The thickness of the cavity for molding the thickness T1 of the rim on the side including the gate is the thickness of the cavity 50 for forming the rim formed by the fixed side mold. The thickness of the cavity for molding the thickness T2 of the rim on the side opposite to the side including the gate is the thickness of the cavity 51 for forming the rim formed by the movable side mold. In the mold used in this process, the thickness of the cavity 50 for forming the rim formed by the fixed side mold and the thickness of the cavity 51 for forming the rim formed by the movable side mold are the same. The resin gear, which is molded by injecting melted resin into the mold and cooling the melted resin, is taken out. FIG. 3 shows a state in which the melted resin is injected into the cavity from the gate 16. The melted resin injected into the cavity is cooled by water pipes 41 and 42 for cooling the mold. Thereafter, the mold is opened by moving the movable side mold away from the fixed side mold, the teeth portion forming piece 44 and the axis forming piece 46 are retreated, and an ejector pin 47 is protruded, so that the resin gear, which is a molded component, is taken out.

In step S2, the resin gear which is molded and taken out in step S1 is stored in a constant environment for a certain period of time or more. The storage environment may be arbitrarily determined. For example, the resin gear immediately after being molded is stored in an environment of room temperature of 25±5° C. and humidity of 50±10% for 24 hours or more. Thereby, the shrinkage state of the resin gear can be stabilized, so that the measurement performed in the next process can be accurately performed. The state of the resin gear after being stored is indicated by dashed lines 19 in FIG. 4A. The rim indicated by solid lines in FIG. 4A shows a state in which the resin gear has not yet shrunk and is not deformed. On the other hand, the rim shape 19 of the resin gear which is stored for a certain period of time or more and whose shrinkage state is stabilized is deformed and inclined inward.

In step S3, a predetermined measurement is performed on the resin gear which has passed through step S2. Diameters of the tooth tip portions of the tooth tips of both ends of the gear are measured and the amount of inclination r of the rim (the deformation amount of addendum circle) which is a difference between the diameters of the tooth tip portions of both ends is calculated. The tooth tips of both ends of the gear are both ends of the gear in the axis direction (portions denoted by reference numerals 22 and 23 in FIG. 4A). The diameter of the tooth tip portion is a line in parallel with the central plane of the web and the length of a line segment 25 between the center 27 of the tooth and the center 15 of the gear. (see FIG. 4B)

In step S4, whether or not to modify the mold is determined on the basis of the measurement result in step S3. However, regarding the measurement result of the resin gear molded without modifying the mold, step S4 is ignored and the process proceeds to step S5 unconditionally. In step S4, the determination is performed based on an accuracy standard of the resin gear desired to be finally obtained, so that the determination method is not limited.

In step S5, modification/correction of the mold is performed based on the measurement result of step S3. The amount of modification may be arbitrarily determined. For example, the injection mold is modified so that the thickness of the rim on the side including the gate is reduced by the amount of inclination r of the rim (the deformation amount of addendum circle) obtained in step S3. How much the mold should be modified can be estimated by measuring the amount of inclination. Therefore, it is possible to manufacture a gear having sufficient rigidity without unduly reducing the thickness of the rim. Specifically, the fixed side mold is recreated so that the thickness of the cavity for forming the rim that is formed by the fixed side mold is reduced. Or, a cavity portion for forming the rim that is formed by the movable side mold is reduced by a predetermined amount. Thereby, the thickness of the cavity for forming the rim formed by the fixed side mold can be smaller than the thickness of the cavity for forming the rim formed by the movable side mold. Therefore, it is possible to manufacture a resin gear having a relationship of h1≧h2 and T1h1<T2h2.

In the manufacturing method of the resin gear of the first embodiment, the series of steps S1 to S5 are repeatedly performed at least one time. The repetition ends only when it is determined that the proceeding to step S5 is unnecessary in the determination process in step S4.

In the (conventional) resin gear before correction, when the thickness and the height of the rim on the side including the gate are T1 and h1 respectively and the thickness and the height of the rim on the side opposite to the side including the gate are T2 and h2 respectively, h1=h2 and T1h1=T2h2 are established. The volume of the rim on the fixed side mold and the volume of the rim on the movable side mold are the same, so that the rim is affected by the heat of the fixed side mold and a shrinkage behavior occurs in which the rim is inclined by r. In the resin gear of the present embodiment, the volume of the rim formed by the fixed side mold is smaller than the volume of the rim formed by the movable side mold. The volume of the rim on the fixed side mold, that is, the volume of the rim on the side including the gate, is small, so that the heat effect of the fixed side mold is smaller than that of a conventional resin gear. As a result, the shrinkage of the rim is reduced, so that it is possible to reduce the amount of inclination r to be smaller than that of a conventional gear. Thereby, it is possible to reduce the amount of change u of the tooth on the theoretical pitch circle which directly affects the total alignment error, so that it is possible to mold an accurate resin gear.

In a resin gear in which the relationship between the height h1 of the rim on the side including the gate and the height h2 of the rim on the side opposite to the side including the gate is h1≧h2, it is assumed that the relationship between the thickness T1 in addition to the height h1 of the rim on the side including the gate and the thickness T2 in addition to the height h2 of the rim on the side opposite to the side including the gate is T1h1<T2h2. Thereby, the volume of the rim formed by the fixed side mold is always smaller than the volume of the rim formed by the movable side mold. The difference between these volumes of the rims causes a difference between the accumulated heats in the rims during injection molding of the resin gear. As a result, the heat accumulated in the rim formed by the fixed side mold, that is, the heat accumulated in the rim on the side including the gate, becomes smaller. This is opposite to the tendency in which the rim on the side including the gate accumulates heat because the mold temperature of the fixed side mold is high. Therefore, an effect of suppressing a phenomenon in which the rim is deformed and inclined inward is generated and the degradation of the total alignment error can be suppressed.

In the present embodiment, an example is described in which the volume of the rim formed by the fixed side mold is reduced by correction to be smaller than the volume of the rim formed by the movable side mold. However, from the beginning, if the resin gear is molded by using a mold in which the relationship between the thickness T1 in addition to the height h1 of the rim on the side including the gate and the thickness T2 in addition to the height h2 of the rim on the side opposite to the side including the gate is T1h1<T2h2, of course, the same effect can be obtained. In other words, the effect of suppressing a phenomenon in which the rim is deformed and inclined inward is generated and the degradation of the total alignment error can be suppressed.

Although, in the first embodiment, a case is shown in which the shape when the rim is cut along a plane perpendicular to the central plane of the web is rectangular, the shape is not limited to rectangular.

### Second Embodiment

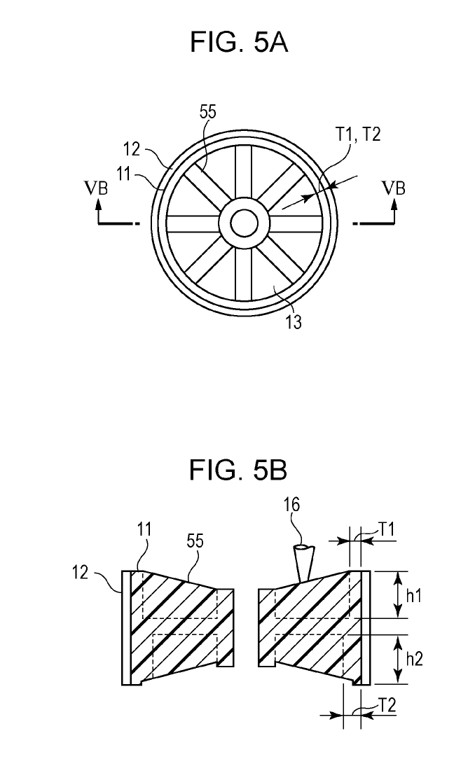

FIGS. 5A and 5B are schematic diagrams showing a resin gear representing a second embodiment of the present disclosure. FIG. 5A is a top view. FIG. 5B is a cross-sectional view taken along line VB-VB in FIG. 5A. The same reference numerals are given to the same components as those in FIGS. 1A to 1C and the description thereof is omitted. In the second embodiment, a resin gear is shown in which ribs 55 are radially disposed between the webs 13 planarly extending from the inner circumference surface of the rim toward the central axis 15. The shapes of the web and the rim are indicated by dashed lines. The position 16 of the gate which is an inlet of melted resin is disposed at a tip portion of a rib 55 radially disposed on one side. However, it is not limited to this, and the gate may be disposed on one side of a web formed between the ribs 55. Reference symbol h1 denotes a height of the rim from the web surface on the side including the gate and reference symbol T1 denotes a thickness of the rim on the side including the gate. Reference symbol h2 denotes a height of the rim from the web surface on the side opposite to the side including the gate and reference symbol T2 denotes a thickness of the rim on the side opposite to the side including the gate. It is possible to reduce the volume of the rim on the side including the gate by increasing the thickness T2 of the rim on the side opposite to the side including the gate to be greater than T1. As a result, the influence of the heat can be reduced, so that it is possible to suppress the deformation of the rim caused by the heat. Thereby, it is possible to reduce the amount of change of the tooth on the theoretical pitch circle which directly affects the total alignment error, so that it is possible to mold an accurate resin gear.

### Third Embodiment

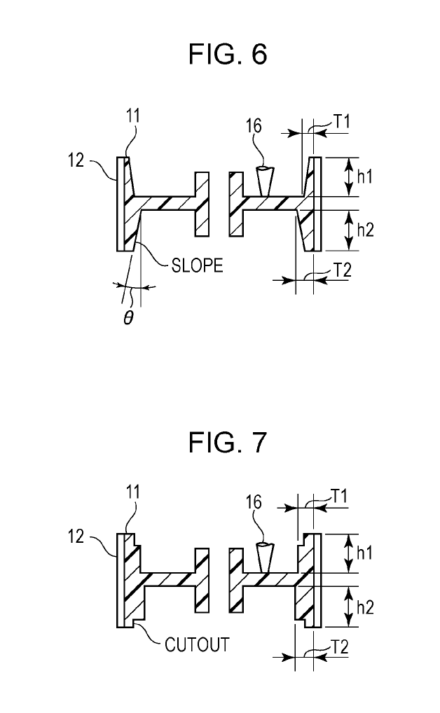

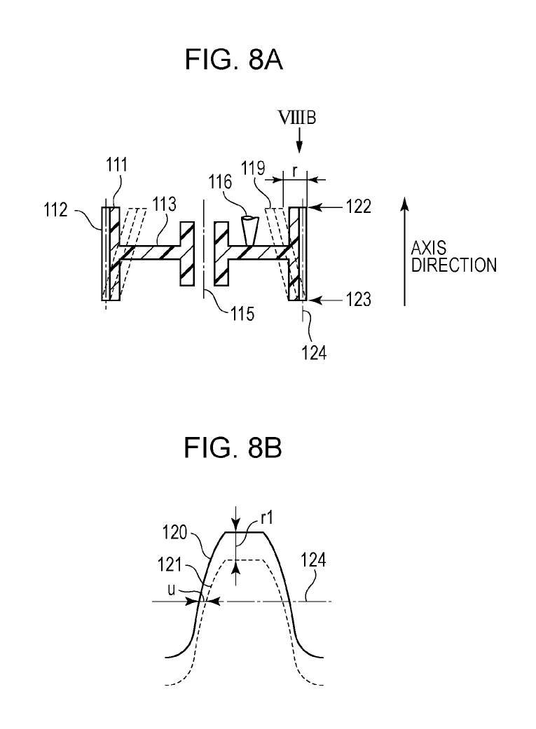

FIG. 6A is a schematic diagram showing a resin gear representing a third embodiment of the present disclosure. The same reference numerals are given to the same components as those in FIGS. 1A to 1C and the description thereof is omitted. In the third embodiment, a resin gear is shown in which a slope is added to the inner circumference surface of the rim. Reference symbol 8 denotes a rim slope angle. The position 16 of the gate which is an inlet of melted resin is disposed on one side of the web in the same manner as in the first embodiment. Reference symbol h1 denotes a height of the rim from the web surface on the side including the gate and reference symbol T1 denotes a maximum value of the thickness of the rim on the side including the gate. Reference symbol h2 denotes a height of the rim from the web surface on the side opposite to the side including the gate and reference symbol T2 denotes a maximum value of the thickness of the rim on the side opposite to the side including the gate. It is possible to reduce the volume of the rim on the side including the gate by increasing the thickness T2 of the rim on the side opposite to the side including the gate to be greater than T1. As a result, the influence of the heat can be reduced, so that it is possible to suppress the deformation of the rim caused by the heat. Thereby, it is possible to reduce the amount of change of the tooth on the theoretical pitch circle which directly affects the total alignment error, so that it is possible to mold an accurate resin gear.

### Fourth Embodiment

FIG. 7 is a schematic diagram showing a resin gear representing a fourth embodiment as disclosed herein. The same reference numerals are given to the same components as those in FIGS. 1A to 1C and the description thereof is omitted. In the fourth embodiment, a resin gear is shown in which the thickness of the rim varies in the axis direction. The position 16 of the gate which is an inlet of melted resin is disposed on one side of the web in the same manner as in the first embodiment. Reference symbol h1 denotes a height of the rim from the web surface on the side including the gate and reference symbol T1 denotes a maximum value of the thickness of the rim on the side including the gate. Reference symbol h2 denotes a height of the rim from the web surface on the side opposite to the side including the gate and reference symbol T2 denotes a maximum value of the thickness of the rim on the side opposite to the side including the gate. It is possible to reduce the volume of the rim on the side including the gate by increasing the thickness T2 of the rim on the side opposite to the side including the gate to be greater than T1. The rim may have a portion (a cutout portion) thinner than the thicknesses T1 and T2 at an end portion thereof. It is possible to reduce the volume of the rim on the side including the gate to be smaller than the volume of the rim on the side opposite to the side including the gate by the thin portion (cutout portion). As a result, the influence of the heat can be reduced, so that it is possible to suppress the deformation of the rim caused by the heat. Thereby, it is possible to reduce the amount of change of the tooth on the theoretical pitch circle which directly affects the total alignment error, so that it is possible to mold an accurate resin gear.

### EXAMPLES

Hereinafter, the present invention will be specifically described with reference to examples. However, it is understood that the present invention is not limited to the examples.

The resin gear of the first embodiment shown in FIG. 1 is molded by using an example of the manufacturing method of the resin gear disclosed herein. Tenac (registered trademark) HC750 manufactured by Asahi Kasei Chemicals Corporation is used as a resin material. The resin gear obtained by the molding has an addendum circle diameter of φ70, a module of 0.5, a pressure angle of 20°, the number of teeth 135, and a helix angle of 20° left.

### Comparative Example 1

First, injection molding is performed by using a mold in which the height of the rim and the thickness of the rim on the side including the gate (the fixed side mold) and on the side opposite to the side including the gate (the movable side mold) are 5 mm and 1.5 mm respectively (h1≧h2 and T1h1=T2h2) on the basis of step S1. In the molded resin gear, h1=h2=5.0 mm and T1=T2=1.5 mm are measured. The amount of inclination r of the rim is measured by a three-dimensional measuring machine or a roundness measuring machine and the total alignment error is measured by a gear testing machine. The result of the measurement is shown in the comparative example 1 in Table 1.

### Example 1

Next, modification/correction of the mold is performed based on the result of the measurement. Regarding the amount of modification, the injection mold is modified so that the thickness of the rim T1 on the side including the gate is reduced by the amount of inclination of the rim (the deformation amount of addendum circle) r=0.12. When the injection molding is performed using the modified mold, T1=1.38, h1=h2=5.0 mm, and T2=1.5 mm are measured. Next, the amount of inclination r of the rim and the total alignment error are measured. The measurement result is shown in the example 1. T1 is modified to 1.38, so that T1h1<T2h2 is established and a resin gear in which the amount of inclination r of the rim and the total alignment error are small can be obtained.

### Example 2

The mold used in the example 1 is further modified so that T1 equals 1.315. When the injection molding is performed using the modified mold, T1=1.315, h1=h2=5.0 mm, and T2=1.5 mm are measured. Next, the amount of inclination r of the rim and the total alignment error are measured. The measurement result is shown in the example 2. T1 is modified to 1.315, so that T1h1<T2h2 is established and a resin gear in which the amount of inclination r of the rim and the total alignment error are small can be obtained. When comparing the example 1 and the example 2, it is known that the example 2 in which the modification is repeated has a good result regarding the amount of inclination of the rim.

### Comparative Example 2

In a comparative example 2, an example is shown in which the height of the rim of the mold shown in the comparative example 1 is modified. In the comparative example 2, the height of the rim on the side including the gate is modified to h1=6 from that in the comparative example 1. A resin gear is molded by performing injection molding using this mold. In the molded resin gear, the heights h1 and h2 of the rim and the thicknesses T1 and T2 of the rim on the side including the gate (the fixed side mold) and on the side opposite to the side including the gate (the movable side mold), the amount of inclination r of the rim, and the total alignment error are measured. The measurement result is shown in the comparative example 2 in Table 1. The measurement result shows T1h1>T2h2. As the volume of the rim on the side including the gate becomes greater than the volume of the rim on the side opposite to the side including the gate, the heat accumulated in the rim on the side including the gate becomes greater than that in the rim on the side opposite to the side including the gate, so that the shrinkage difference occurs and the amount of inclination r of the rim is greater than that in the comparative example 1.

### Example 3

Next, modification/correction of the mold is performed based on the measurement result of the comparative example 2. Regarding the amount of modification, the mold is modified so that T1 equals 1.2 considering the amount of inclination of the rim (the deformation amount of addendum circle). A resin gear is molded by using the modified mold. In the molded resin gear, the heights h1 and h2 of the rim and the thicknesses T1 and T2 of the rim on the side including the gate (the fixed side mold) and on the side opposite to the side including the gate (the movable side mold), the amount of inclination r of the rim, and the total alignment error are measured. The measurement result is shown in the example 3 in Table 1. By the modification of the mold, T1h1<T2h2 is established, so that a resin gear in which the amount of inclination r of the rim and the total alignment error are small can be obtained.

### Example 4

The mold used in the example 3 is further modified so that T1 equals 1. In the resin gear molded by using the modified mold, the heights h1 and h2 of the rim and the thicknesses T1 and T2 of the rim on the side including the gate (the fixed side mold) and on the side opposite to the side including the gate (the movable side mold), the amount of inclination r of the rim, and the total alignment error are measured. The measurement result is shown in the example 4 in Table 1. A resin gear which is more accurate than the resin gear of the example 3 can be obtained by repeating modification of the mold.

There is an obvious correlation between the amount of inclination r of the rim and the total alignment error, and when the amount of inclination r decreases, the total alignment error decreases. Also, it is known that there is a tendency that the smaller T1h1 compared with T2h2, the smaller the amount of inclination r of the rim.

TABLE 1

| | Comparative | Comparative | | | | |
|---|---|---|---|---|---|---|
| Condition | example 1 | example 2 | Example 1 | Example 2 | Example 3 | Example 4 |
| Rim thickness T1 (mm) | 1.5 | 1.5 | 1.38 | 1.315 | 1.2 | 1 |
| Rim height h1 (mm) | 5 | 6 | 5 | 5 | 6 | 6 |
| Rim thickness T2 (mm) | 1.5 | 1.5 | 1.5 | 1.5 | 1.5 | 1.5 |
| Rim height h2 (mm) | 5 | 5 | 5 | 5 | 5 | 5 |
| T1h1 | 7.5 | 9 | 6.9 | 6.575 | 7.2 | 6 |
| T2h2 | 7.5 | 7.5 | 7.5 | 7.5 | 7.5 | 7.5 |
| Amount of inclination r | 0.12 | 0.153 | 0.065 | 0.05 | 0.085 | 0.049 |
| of rim (mm) | | | | | | |
| T1-r | 1.38 | 1.347 | 1.315 | 1.265 | 1.115 | 0.951 |
| Helix form deviation | 84 | 88 | 25 | 32 | 42 | 22.5 |
| (μm) | | | | | | |

Next, the resin gear of the second embodiment shown in FIG. 5 is molded by using an example of the manufacturing method of the resin gear disclosed herein. Tenac (registered trademark) HC750 manufactured by Asahi Kasei Chemicals Corporation is used as a resin material. The resin gear obtained by the molding has an addendum circle diameter of φ70, a module of 0.5, a pressure angle of 20°, the number of teeth 135, and a helix angle of 20° left.

### Comparative Example 3

A comparative example 3 is molded by using a mold for molding a resin gear including ribs 51 radially disposed on the inner circumference surface of the rim. First, injection molding is performed by using a mold in which both thicknesses T1 and T2 of the rim on the side including the gate (the fixed side mold) and on the side opposite to the side including the gate (the movable side mold) are 5 mm. In the molded resin gear, the heights h1 and h2 of the rim and the thicknesses T1 and T2 of the rim on the side including the gate (the fixed side mold) and on the side opposite to the side including the gate (the movable side mold) and the amount of inclination r of the rim are measured. The measurement result is shown in the comparative example 3 in Table 2. The amount of inclination r of the rim is large.

### Example 5

Next, modification/correction of the mold is performed based on the measurement result of the comparative example 3. Regarding the amount of modification, the mold is modified so that T1 equals 1.2 considering the amount of inclination of the rim (the deformation amount of addendum circle). A resin gear is molded by using the modified mold. In the molded resin gear, the heights h1 and h2 of the rim and the thicknesses T1 and T2 of the rim on the side including the gate (the fixed side mold) and on the side opposite to the side including the gate (the movable side mold) and the amount of inclination r of the rim are measured. The measurement result is shown in the example 5 in Table 2. By the modification of the mold, T1h1<T2h2 is established, so that a resin gear in which the amount of inclination r of the rim is small can be obtained.

### Comparative Example 4

In the comparative example 4, an example is shown in which the height of the rim of the mold shown in the comparative example 3 is modified. In the comparative example 4, the height of the rim on the side including the gate is modified to h1=6 from that in the comparative example 3. A resin gear is molded by performing injection molding using this mold. In the molded resin gear, the heights h1 and h2 of the rim and the thicknesses T1 and T2 of the rim on the side including the gate (the fixed side mold) and on the side opposite to the side including the gate (the movable side mold) and the amount of inclination r of the rim are measured. The measurement result is shown in the comparative example 4 in Table 2. The measurement result shows T1h1>T2h2. As the volume of the rim on the side including the gate becomes greater than the volume of the rim on the side opposite to the side including the gate, the heat accumulated in the rim on the side including the gate becomes greater than that in the rim on the side opposite to the side including the gate, so that the shrinkage difference occurs and the amount of inclination r of the rim is greater than that in the comparative example 3.

### Example 6

Next, modification/correction of the mold is performed based on the measurement result of the comparative example 4. Regarding the amount of modification, the mold is modified so that T1 equals 1 considering the amount of inclination of the rim (the deformation amount of addendum circle), and a resin gear is molded by using the modified mold. In the molded resin gear, the heights h1 and h2 of the rim and the thicknesses T1 and T2 of the rim on the side including the gate (the fixed side mold) and on the side opposite to the side including the gate (the movable side mold) and the amount of inclination r of the rim are measured. The measurement result is shown in the example 6 in Table 2. By the modification of the mold, T1h1<T2h2 is established, so that a resin gear in which the amount of inclination r of the rim is small can be obtained.

TABLE 2

| | Comparative | Comparative | | |
|---|---|---|---|---|
| Condition | example 3 | example 4 | Example 5 | Example 6 |
| Rim thickness T1 | 1.5 | 1.5 | 1.2 | 1.2 |
| (mm) | | | | |
| Rim height h1 (mm) | 5 | 6 | 5 | 6 |
| Rim thickness T2 | 1.5 | 1.5 | 1.5 | 1.5 |
| (mm) | | | | |
| Rim height h2 (mm) | 5 | 5 | 5 | 5 |
| T1h1 | 7.5 | 9 | 6 | 7.2 |
| T2h2 | 7.5 | 7.5 | 7.5 | 7.5 |
| Amount of | 0.06 | 0.075 | 0.021 | 0.035 |
| inclination r of | | | | |
| rim (mm) | | | | |

Next, the resin gear of the third embodiment shown in FIG. 6 is molded by using an example of the manufacturing method of the resin gear disclosed herein. Tenac (registered trademark) HC750 manufactured by Asahi Kasei Chemicals Corporation is used as a resin material. The resin gear obtained by the molding has an addendum circle diameter of φ70, a module of 0.5, a pressure angle of 20°, the number of teeth 135, and a helix angle of 20° left.

### Comparative Example 5

A comparative example 5 is molded by using a mold for molding a resin gear in which a slope is added to the inner circumference surface of the rim. First, injection molding is performed by using a mold in which both thicknesses T1 and T2 of the rim on the side including the gate (the fixed side mold) and on the side opposite to the side including the gate (the movable side mold) are 5 mm. In the molded resin gear, the heights h1 and h2 of the rim and the thicknesses T1 and T2 of the rim on the side including the gate (the fixed side mold) and on the side opposite to the side including the gate (the movable side mold) and the amount of inclination r of the rim are measured. The measurement result is shown in the comparative example 5 in Table 3. Reference symbol θ denotes a rim slope angle. The measurement result shows T1h1=T2h2, so that the shrinkage difference occurs and the amount of inclination r of the rim is large.

### Example 7

Next, modification/correction of the mold is performed based on the measurement result of the comparative example 5. Regarding the amount of modification, the mold is modified so that T1 equals 1.2 considering the amount of inclination of the rim (the deformation amount of addendum circle). A resin gear is molded by using the modified mold. In the molded resin gear, the heights h1 and h2 of the rim and the thicknesses T1 and T2 of the rim on the side including the gate (the fixed side mold) and on the side opposite to the side including the gate (the movable side mold) and the amount of inclination r of the rim are measured. The measurement result is shown in the example 7 in Table 3. By the modification of the mold, T1h1<T2h2 is established, so that a resin gear in which the amount of inclination r of the rim is small can be obtained.

### Comparative Example 6

In the comparative example 6, an example is shown in which the height of the rim of the mold shown in the comparative example 5 is modified. In the comparative example 6, the height of the rim on the side including the gate is modified to h1=6 from that in the comparative example 5. A resin gear is molded by performing injection molding using this mold. In the molded resin gear, the heights h1 and h2 of the rim and the thicknesses T1 and T2 of the rim on the side including the gate (the fixed side mold) and on the side opposite to the side including the gate (the movable side mold) and the amount of inclination r of the rim are measured. The measurement result is shown in the comparative example 6 in Table 3. The measurement result shows T1h1>T2h2. As the volume of the rim on the side including the gate becomes greater than the volume of the rim on the side substantially opposite to the side including the gate, the heat accumulated in the rim on the side including the gate becomes greater than that in the rim on the side substantially opposite to the side including the gate, so that the shrinkage difference occurs and the amount of inclination r of the rim is greater than that in the comparative example 5.

### Example 8

Next, modification/correction of the mold is performed based on the measurement result of the comparative example 6. Regarding the amount of modification, the mold is modified so that T1 equals 1.2 considering the amount of inclination of the rim (the deformation amount of addendum circle), and a resin gear is molded by using the modified mold. In the molded resin gear, the heights h1 and h2 of the rim and the thicknesses T1 and T2 of the rim on the side including the gate (the fixed side mold) and on the side opposite to the side including the gate (the movable side mold) and the amount of inclination r of the rim are measured. The measurement result is shown in the example 8 in Table 3. By the modification of the mold, T1h1<T2h2 is established, so that a resin gear in which the amount of inclination r of the rim is small can be obtained.

TABLE 3

| | Comparative | Comparative | | |
|---|---|---|---|---|
| Condition | example 5 | example 6 | Example 7 | Example 8 |
| Rim thickness T1 | 1.5 | 1.5 | 1.2 | 1.2 |
| (mm) | | | | |
| Rim height h1 (mm) | 5 | 6 | 5 | 6 |
| Rim thickness T2 | 1.5 | 1.5 | 1.5 | 1.5 |
| (mm) | | | | |
| Rim height h2 (mm) | 5 | 5 | 5 | 5 |
| Rim slope angle | 1.5 | 1.5 | 1.5 | 1.5 |
| θ(°) | | | | |
| T1h1 | 7.5 | 9 | 6 | 7.2 |
| T2h2 | 7.5 | 7.5 | 7.5 | 7.5 |
| Amount of | 0.09 | 0.101 | 0.045 | 0.038 |
| inclination r | | | | |
| of rim (mm) | | | | |

Table 4 shows a result where the manufacturing method of the present disclosure is used for the resin gear shown in FIG. 7 in which the thickness of the rim varies in the axis direction. The specifications of the resin gear other than the above are the same as those of the comparative example 1 of the example 1. The thicknesses T1 and T2 of the rim are defined by the maximum thicknesses of the rim. The effects of the thicknesses of the rim and the heights of the rim of an improved example 9 and an improved example 10 and a comparative example 8 and a comparative example 9 of a conventional technique are tabulated.

Next, the resin gear of the fourth embodiment shown in FIG. 7 is molded by using an example of the manufacturing method of the resin gear of the present disclosure. Tenac (registered trademark) HC750 manufactured by Asahi Kasei Chemicals Corporation is used as a resin material. The resin gear obtained by the molding has an addendum circle diameter of φ70, a module of 0.5, a pressure angle of 20°, the number of teeth 135, and a helix angle of 20° left.

### Comparative Example 7

A comparative example 7 is molded by using a mold for molding a resin gear in which a slope is added to the inner circumference surface of the rim. First, injection molding is performed by using a mold in which both thicknesses T1 and T2 of the rim on the side including the gate (the fixed side mold) and on the side opposite to the side including the gate (the movable side mold) are 5 mm. In the molded resin gear, the heights h1 and h2 of the rim and the thicknesses T1 and T2 of the rim on the side including the gate (the fixed side mold) and on the side opposite to the side including the gate (the movable side mold) and the amount of inclination r of the rim are measured. The measurement result is shown in the comparative example 7 in Table 4. The measurement result shows T1h1=T2h2, so that the shrinkage difference occurs and the amount of inclination r of the rim is large.

### Example 9

Next, modification/correction of the mold is performed based on the measurement result of the comparative example 7. Regarding the amount of modification, the mold is modified so that T1 equals 1.2 considering the amount of inclination of the rim (the deformation amount of addendum circle). A resin gear is molded by using the modified mold. In the molded resin gear, the heights h1 and h2 of the rim and the thicknesses T1 and T2 of the rim on the side including the gate (the fixed side mold) and on the side opposite to the side including the gate (the movable side mold) and the amount of inclination r of the rim are measured. The measurement result is shown in the example 9 in Table 4. By the modification of the mold, T1h1<T2h2 is established, so that a resin gear in which the amount of inclination r of the rim is small can be obtained.

### Comparative Example 8

In the comparative example 8, an example is shown in which the height of the rim of the mold shown in the comparative example 7 is modified. In the comparative example 8, the height of the rim on the side including the gate is modified to h1=6 from that in the comparative example 7. A resin gear is molded by performing injection molding using this mold. In the molded resin gear, the heights h1 and h2 of the rim and the thicknesses T1 and T2 of the rim on the side including the gate (the fixed side mold) and on the side opposite to the side including the gate (the movable side mold) and the amount of inclination r of the rim are measured. The measurement result is shown in the comparative example 8 in Table 4. The measurement result shows T1h1>T2h2. As the volume of the rim on the side including the gate becomes greater than the volume of the rim on the side substantially opposite to the side including the gate, the heat accumulated in the rim on the side including the gate becomes greater than that in the rim on the side substantially opposite to the side including the gate, so that the shrinkage difference occurs and the amount of inclination r of the rim is greater than that in the comparative example 7.

### Example 10

Next, modification/correction of the mold is performed based on the measurement result of the comparative example 8. Regarding the amount of modification, the mold is modified so that T1 equals 1.2 considering the amount of inclination of the rim (the deformation amount of addendum circle), and a resin gear is molded by using the modified mold. In the molded resin gear, the heights h1 and h2 of the rim and the thicknesses T1 and T2 of the rim on the side including the gate (the fixed side mold) and on the side opposite to the side including the gate (the movable side mold) and the amount of inclination r of the rim are measured. The measurement result is shown in the example 10 in Table 4. By the modification of the mold, T1h1<T2h2 is established, so that a resin gear in which the amount of inclination r of the rim is small can be obtained.

TABLE 4

| | Comparative | Comparative | | Example |
|---|---|---|---|---|
| Condition | example 7 | example 8 | Example 9 | 10 |
| Rim thickness T1 | 1.5 | 1.5 | 1.2 | 1.2 |
| (mm) | | | | |
| Rim height h1 (mm) | 5 | 6 | 5 | 6 |
| Rim thickness T2 | 1.5 | 1.5 | 1.5 | 1.5 |
| (mm) | | | | |
| Rim height h2 (mm) | 5 | 5 | 5 | 5 |
| T1h1 | 7.5 | 9 | 6 | 7.2 |
| T2h2 | 7.5 | 7.5 | 7.5 | 7.5 |
| Amount of | 0.08 | 0.095 | 0.061 | 0.055 |
| inclination r | | | | |
| of rim (mm) | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-043965 filed Feb. 29, 2012, which is hereby incorporated by reference herein in its entirety.

What is claimed is:

1. A resin gear comprising:
a rim;
teeth configured to be formed on an outer circumference of the rim; and
a web configured to be bonded to an inner circumference surface of the rim,
wherein the resin gear, which has a height h1 of the rim from a first surface of the web, a thickness T1 of the rim on a side of the first surface, a height h2 of the rim from a second surface opposite to the first surface of the web, and a thickness T2 of the rim on a side of the second surface opposite to the first surface, such that h1≧h2, and satisfies T1h1<T2h2.

2. The resin gear according to claim 1, wherein ribs are radially disposed between the webs.

3. The resin gear according to claim 1, wherein a slope is added to the inner circumference surface of the rim.

4. The resin gear according to claim 1, wherein an end portion of the rim on the side of the first surface has a portion thinner than the thickness T1 and an end portion of the rim on the side of the second surface has a portion thinner than the thickness T2.

5. The resin gear according to claim 1, wherein the resin is polyacetal.

6. A manufacturing method of a resin gear in which a resin gear including a rim is molded by injecting melted resin into a mold including a cavity formed by at least a fixed side mold and a movable side mold, wherein
the resin gear is molded so that a thickness of a cavity for forming the rim formed by the fixed side mold is smaller than a thickness of a cavity for forming the rim formed by the movable side mold.

7. A manufacturing method of a resin gear which is a molding method of a resin gear in which a resin gear including a rim is molded by injecting melted resin into a mold including a cavity formed by at least a fixed side mold and a movable side mold, the manufacturing method comprising:
a step of removing a resin gear molded by injecting melted resin into a mold for molding the resin gear, in which a thickness of a cavity for forming the rim formed by the fixed side mold, and a thickness of a cavity for forming the rim formed by the movable side mold, are the same and cooling the melted resin;
a step of storing the resin gear which is removed;
a step of measuring an amount of inclination of the rim after storing;
a step of modifying the mold so the thickness of the cavity for forming the rim formed by the fixed side mold is reduced on the basis of the amount of inclination of the rim; and
a step of molding a resin gear by using the modified mold.

8. The manufacturing method of a resin gear according to claim 7, wherein the step of modifying the mold reduces the thickness of the cavity for forming the rim formed by the fixed side mold by the amount of inclination of the rim.
